(19) United States
(12) Patent Application Publication
(10) Pub. No.: US 2004/0055819 A1
(43) Pub. Date: Mar. 25, 2004

(54) Attic door blanket

(76) Inventors: James Patrick Lynn, Jackson, NJ (US); Dorothy June Lynn, Jackson, NJ (US)

Correspondence Address: James Lynn, 3 Salem Lane, Jackson, NJ, 08527, US

(21) Appl. No.: 10/251,257

(22) Filed: Sep. 23, 2002

(51) Int. Cl. E06C 9/00

(52) U.S. Cl. 182/46; 182/77

(57) ABSTRACT

A thermal insulating cover is described along with a method of manufacturing a cover for use over a set of attic stairs, when they are retracted into the ceiling. The cover is made of two major protective surfaces, surrounding a insulating material to form a blanket, that is then cut and folded to form a box, that is fastened together to form the cover.

A thermal insulating cover is described along with a method of manufacturing a cover for use over a set of attic stairs, when they are retracted into the ceiling. The cover is made of two major protective surfaces, surrounding a insulating material to form a blanket, that is then folded to form a box, that is fastened together to form the cover.

### FIELD OF THE INVENTION

This invention relates to insulating covers and more particularly to insulating covers that are used over attic stairs.

### BACKGROUND OF THE INVENTION

As is well known and understood, a building such as a very leaky house will be very uncomfortable and will have high energy bills. This is due to air infiltration, conduction, and convection bringing in outside temperatures, into a temperature controlled environment or allowing a temperature controlled environment to escape to the outside air. According to the department of energy, it is desirable to insulate the ceiling area because it is one of the most cost effective energy efficient measures. It not only reduces heat loss in the winter and heat gains in the summer, ceiling insulation improves comfort by bringing ceiling temperatures closer to room temperatures. The attic door, although mounted on the ceiling is not only not insulated, but it is also usually very leaky. A typical attic door is usually made of quarter inch plywood with an R-value of less than one and is usually poorly fitted. Attic doors have been insulated in the past in many different ways. They go from the simplest that do not cover the whole door, to the more complex that turn into a construction project in your attic.

The insulating cover that is described by Robert A. Edwards in U.S. Pat. No. 4,151,894 describes an inverted box like cover that has a handle and wheels. It sounds like a very heavy item and would also be a very awkward to ship and install.

The Scuttle hole insulation system that Robert Wessley describes in U.S. Pat. No. 6,223,490 comprises of numerous parts including a cap, locking channels, and a sleeve that all have to be assembled together, and may be outside the scope of ability of someone that is not mechanically inclined.

### DESCRIPTION OF THE INVENTION

The preferred embodiment of this invention consists of a blanket made of two major sides of foil, surrounding a insulating material, in this case a bubble type insulation that is filled with air or a gas. The two major external lengths are then folded inward to approximately three inches to not only add rigidity to the blanket but to also create pockets if additional weight is needed to help the finished product seal to the attic floor. The major lengths are then cut in such a way that when folded for the second time they will engage with the two minor widths. The two minor external widths are also folded inward three inches for rigidity and to create pockets for additional weight. The four sides are then folded perpendicular approximately six inches, away from the major blanket area, with the extra flaps from the major lengths, being folded into the pockets of the minor width to remain parallel and tightly behind the minor widths. The corners will be fastened together, along with any other fastening that is needed along the sides to form the cover.

### BRIEF DESCRIPTION OF THE DRAWINGS

These and other features of the present invention will be clearly understood from a consideration of the following description, taken in connection with the accompanying drawing, in which:

FIG. 1 is a perspective view, helpful in understanding that this invention is constructed from one single blanket of insulation and embodies the principles of this invention;

FIG. 2 is a perspective of the blanket after it has been folded approximately three inches on all its external sides, and folded once again, approximately six inches along its major lengths.

FIG. 3 is a perspective of the blanket completely folded to form an inverted box along with the inside folds that connect the major lengths to the minor widths to give this box strength and rigidity. The drawing also shows the inside pocket around the inside perimeter that weight may be added at a later time to help the blanket seal to the attic floor.

FIG. 3A is a perspective of the inverted box from the outside.

FIG. 4 is a perspective of the blanket in a folded state from the radius side of the folded blanket.

FIG. 4A is a perspective of the blanket in a folded state showing the side opposite the radius side of the fold.

FIG. 5. is a cut away perspective from the side of the stairs being folded up into the attic door cover.

FIG. 5A. is a cut away perspective of the attic door cover from the minor side of the cover and opening, after receiving the attic stairs in their retracted position.

FIG. 6. is a view from the underside of the cover.

### DETAILED

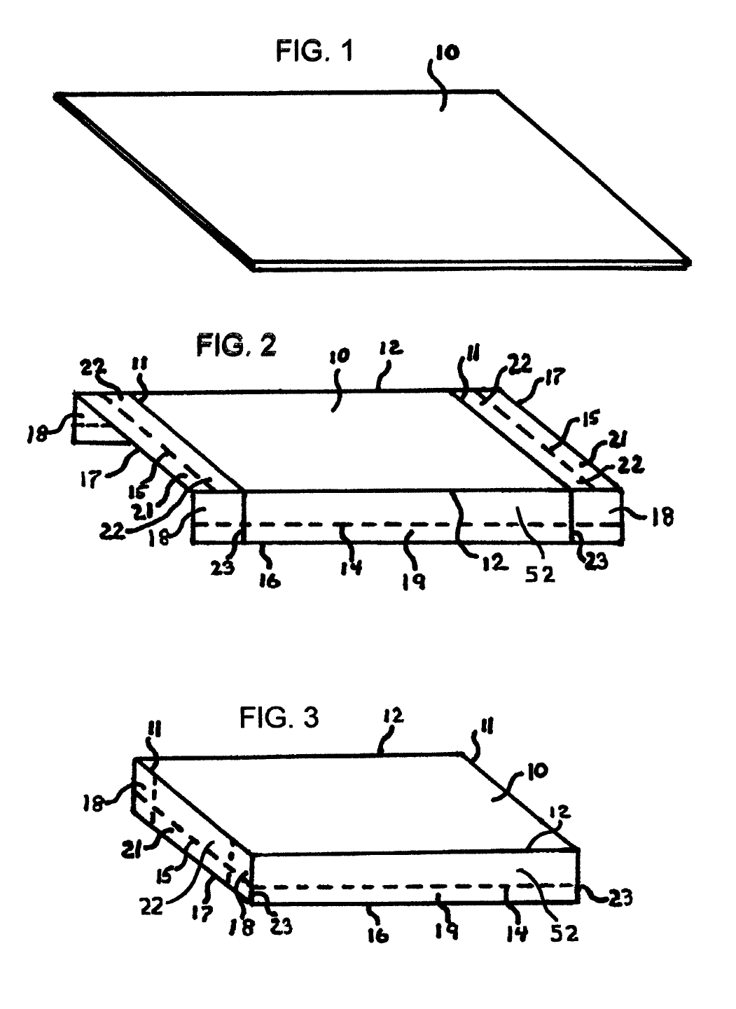

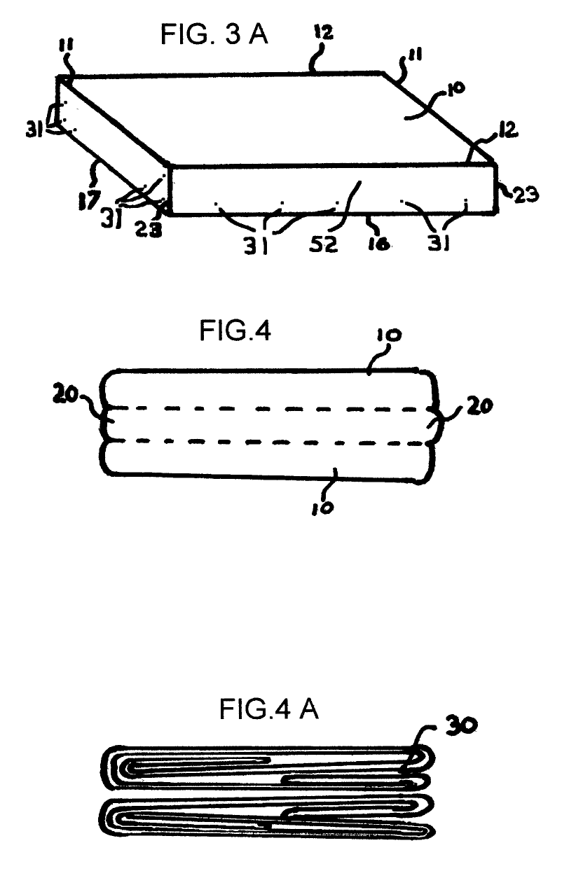

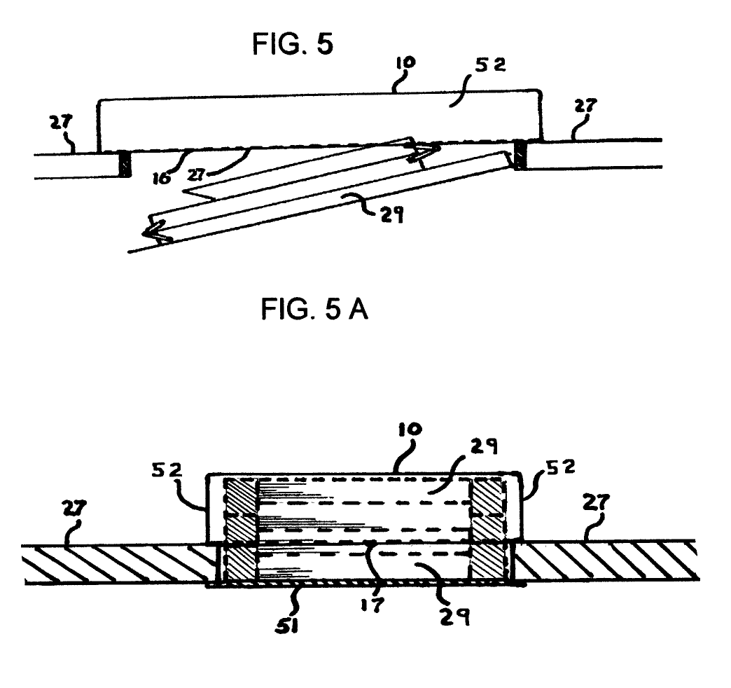

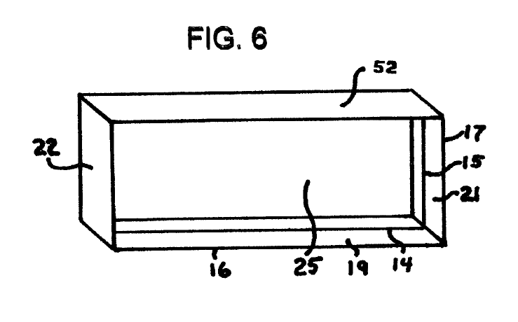

While there have been described what are considered to be preferred embodiments of the present invention, it will be readily understood by those skilled in the art that modifications can be made without departing from the scope of the teachings herein, of using an attic door blanket and, or, the way it is constructed to act as a means of insulating an attic door. For at least such reason, therefore, resort should be had to the claims appended hereto for a true understanding of the scope of the invention. Referring to FIG. 1, it shows the insulating blanket in a unfolded state, with 10 indicating what will be the external top surface of the cover. FIG. 2 shows the blanket with the two major lengths 52, folded at 12 which is approximately nine inches from the edge 14 by way of 16. Item 11 indicates where the folds will be on the minor widths, also approximately nine inches from the edge 15 by way of 17. Items 16 and 17 indicate a fold that was made approximately three inches from the edge, 14 and 15, facing inward and against the inside walls and fastened against the walls. Items 19 and 21 indicate the folded sections which not only add rigidity to the blanket, but also form pockets where weight may be added at a later time to help the blanket seal against the attic floor at 16 and 17. Item 18 is a short section of the major side wall that is folded at 23 to be parallel to 22 when it is folded downward 90 degrees at 11 to form the minor width wall. Items 11 and 22 can be interlocked together at this point and then fastened together with the corner of the cover being formed at 23. FIG. 3 indicates all sides of the cover folded and fastened. Item 10 indicates the top external surface of the cover, 11 and 12 show the folds that form the sides 22 and 52, 14 and 15 show the edges of the blanket after they have been folded inward, 18 is shown, folded behind the minor sides 22, 19 and 21 is the hem that gives rigidity and 23 forms the corners, and 16 and 17 is the edge of the blanket that seals against the attic floor. FIG. 4 indicates the major parts that form the cover. Item 10 is the top external surface, 11 and 12 are the folds that form the top and sides 22 and 52, 23 forms the corners, and 16 and 17 form the bottom sealing surface and 31 indicates that this cover has been fastened together. FIG. 5 shows the blanket folded for shipping and storage after it has been folded several times. The side that is shown is the radius of the fold 20, along with the top external sides of the cover 10. FIG. 6 shows the side opposite FIG. 5 with the many folds of the cover 30 FIG. 7 shows the cover along its major side receiving the attic stairs 29 with 10 indicating the top external side of the cover and 27 shows the floor of the attic with the edge of the cover 16 sealing against it. FIG. 8 shows the minor side of the cover with 10 being the top external surface and the edge of the cover 17 sealing against the floor of the attic 27, with the stairs 29 recessed inside. Item 51 indicates the attic door closed against the opening to the attic. Item 52 is the side of the cover. FIG. 9 shows the underside of the box 25, with the sealing surfaces of the cover 16 and 17 for sealing against the attic floor, along with the hem sections 19 and 21 for rigidity. The inside edge of the cover 14 and 15, is shown along with 22 and 52, the outside minor and major external sides.

We claim:

1. A thermal insulating cover comprising a thermal insulating blanket, that when folded and fastened forms a inverted box, that will rest on the floor of a attic, to receive therein a set of attic stairs in a folded position.
(a) A process of folding and fastening a insulating blanket, in such a way, as to form a box with five external sides and five internal sides.
(b) A thermal blanket as in claim one, that when folded and fastened, to form a box, offers a lightweight, resilient, flexible, thermal insulating attic stair door cover.
(c) A thermal insulating cover that has foil on its external sides to reflect radiant heat.
(d) A thermal insulating cover that has foil on its internal sides to reflect radiant heat.
(e) The foil as described in claims four and five, is also used as a protective layer.

2. A thermal insulating cover as described in claim one, that is used to prevent or reduce drafts between a temperature controlled environment and the space in the attic.

3. The four vertical sides of the inverted box as described in claim one, having a hem folded and fastened to it for rigidity.
(a) The hem may be used as a pocket when the cover is in the inverted position to allow weights to be added to the cover for a better seal against the floor of the attic.

4. The thermal insulating cover as described in claim one is also a vapor barrier.

5. The foil as described in claims four and five may also be a metallic coating that is used to cover a protective layer on its external surfaces.
